(19) United States
(12) Patent Application Publication
(10) Pub. No.: US 2024/0189633 A1
(43) Pub. Date: Jun. 13, 2024

(54) RESPIRATORY PROTECTIVE DEVICE WITH IMPROVED SOUND INSULATION

(71) Applicant: HONEYWELL INTERNATIONAL INC., Charlotte, NC (US)

(72) Inventors: En Yi CHEN, Charlotte, NC (US); Hang TIAN, Charlotte, NC (US); Da Cheng YE, Charlotte, NC (US)

(21) Appl. No.: 18/521,618

(22) Filed: Nov. 28, 2023

(30) Foreign Application Priority Data
Dec. 13, 2022 (CN) 202211594169.5

(51) Int. Cl. A62B 18/08; A62B 18/00

(52) U.S. Cl. CPC A62B 18/08; A62B 18/006

(57) ABSTRACT

Example respiratory protective devices with improved sound insulation are provided. For example, an example respiratory protective device comprises an inner shell component and a fan mounting component. In some examples, the inner shell component defines at least one acoustic insulation portion that is indented on an outer surface of the inner shell component. In some embodiments, the fan mounting component protrudes from an indented surface of the at least one acoustic insulation portion and comprising a plurality of acoustic insulation ribs.

### CROSS-REFERENCE TO RELATED APPLICATIONS

This application claims priority pursuant to 35 U.S.C. 119(a) to Chinese Application No. 202211594169.5, filed Dec. 13, 2022, which application is incorporated herein by reference in its entirety.

### FIELD OF THE INVENTION

Example embodiments of the present disclosure relate generally to respiratory protective devices and, more particularly, to apparatuses and methods for providing respiratory protective devices with improved sound insulation.

### BACKGROUND

Applicant has identified many technical challenges and difficulties associated with masks. For example, many users may need to conduct telephone calls while wearing masks. However, many masks do not provide sound insulation.

### BRIEF SUMMARY

Various embodiments described herein relate to methods, apparatuses, and systems for providing respiratory protective devices with improved sound insulation.

In some embodiments, a respiratory protective device comprises an inner shell component and a fan mounting component.

In some embodiments, the inner shell component defines at least one acoustic insulation portion that is indented on an outer surface of the inner shell component. In some embodiments, the fan mounting component protrudes from an indented surface of the at least one acoustic insulation portion and comprises a plurality of acoustic insulation ribs. In some embodiments, the plurality of acoustic insulation ribs defines at least one curved ventilation channel. In some embodiments, a ventilation inlet width associated with the at least one curved ventilation channel is larger than a ventilation outlet width associated with the at least one curved ventilation channel.

In some embodiments, each of the plurality of acoustic insulation ribs comprises a ventilation inlet end. In some embodiments, the ventilation inlet ends of two of the plurality of acoustic insulation ribs define a ventilation inlet opening.

In some embodiments, the respiratory protective device further comprises at least one fan component secured in the fan mounting component and defining at least one fan outlet. In some embodiments, the at least one fan outlet is aligned with the ventilation inlet opening.

In some embodiments, the at least one acoustic insulation portion defines an air outlet opening on a side surface of the at least one acoustic insulation portion of the inner shell component.

In some embodiments, each of the plurality of acoustic insulation ribs comprises a ventilation outlet end positioned at the air outlet opening. In some embodiments, ventilation outlet ends of two of the plurality of acoustic insulation ribs define a ventilation outlet opening.

In some embodiments, a ratio between the ventilation inlet width and the ventilation outlet width is in a range between 1:1 and 2:1.

In some embodiments, a ratio between the ventilation inlet width and the ventilation outlet width is 2:1.

In some embodiments, a ratio between the ventilation inlet width and the ventilation outlet width is more than 2:1.

In some embodiments, the plurality of acoustic insulation ribs comprises acoustic insulation material.

In some embodiments, the fan mounting component further comprises a fan cover positioned on top of the plurality of acoustic insulation ribs. In some embodiments, the fan cover comprises acoustic insulation material.

In some embodiments, the at least one acoustic insulation portion comprises a left acoustic insulation portion and a right acoustic insulation portion.

In some embodiments, the respiratory protective device further comprises: a central acoustic insulation insert positioned between the left acoustic insulation portion and the right acoustic insulation portion and comprising a plurality of insulation ribs.

In some embodiments, the central acoustic insulation insert is secured to an inner surface of the inner shell component.

In some embodiments, the plurality of insulation ribs comprises acoustic insulation material.

In some embodiments, the plurality of insulation ribs is in parallel arrangement with one another.

In some embodiments, each of the plurality of insulation ribs comprises a curved top surface.

In some embodiments, the left acoustic insulation portion defines a left air outlet opening. In some embodiments, the right acoustic insulation portion defines a right air outlet opening.

In some embodiments, at least one of the plurality of insulation ribs is positioned between the left air outlet opening and the right air outlet opening.

In some embodiments, the inner shell component defines an exhalation opening.

In some embodiments, the central acoustic insulation insert is positioned above the exhalation opening.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example side view of an example respiratory protective device in accordance with some example embodiments described herein;

FIG. 2A illustrates an example exploded view of example components of an example mask component in accordance with some example embodiments described herein;

FIG. 2B illustrates another example exploded view of example components of an example mask component in accordance with some example embodiments described herein;

FIG. 2C illustrates another example back view of an example mask component in accordance with some example embodiments described herein;

FIG. 3 provides an example block diagram illustrating example components associated with an example respiratory protective device in accordance with some embodiments of the present disclosure;

FIG. 4 provides an example circuit diagram illustrating example data communications between example components of an example respiratory protective device in accordance with some example embodiments described herein;

FIG. 5 illustrates an example diagram illustrating example sound wave progressions in relation to an example ventilation opening in accordance with some embodiments of the present disclosure;

FIG. 6 illustrates an example diagram illustrating example sound wave progressions through an example sound insulation structure in accordance with some embodiments of the present disclosure;

FIG. 7 illustrates an example fan component in accordance with some embodiments of the present disclosure;

FIG. 8A illustrates an example partially exploded view of an example fan mounting component on an example inner shell component in accordance with some embodiments of the present disclosure;

FIG. 8B illustrates an example top view of an example fan mounting component on an example inner shell component in accordance with some embodiments of the present disclosure;

FIG. 8C illustrates an example side view of an example acoustic insulation portion in accordance with some embodiments of the present disclosure;

FIG. 9A illustrates an example back view of an example inner shell component in accordance with some embodiments of the present disclosure; and

FIG. 9B illustrates an example exploded view of an example inner shell component in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” “in electronic communications with,” or “connected” in the present disclosure refers to two or more elements or components being connected through wired means (such as, but not limited to, through direct coupling or conductive coupling) and/or connected through wireless means (such as, but not limited to, through electromagnetic induction or capacitive coupling), such that electrical energy (such as, but not limited to, electrical voltage, electrical current, and/or the like) can be transferring between and among the two or more elements or components.

Respiratory protective devices (such as, but not limited to, masks, respirators, and/or the like) can protect the health of not only those who wear them, but also those around people who wear them. For example, when a user wears a respiratory protective device, the respiratory protective device can prevent inhalation of hazardous substances (such as, but not limited to, harmful dusts, smokes, mists, gasses, vapors, and/or the like) from the environment. As another example, respiratory protective devices can reduce the likelihood and the amount of droplets and aerosols that are released by users who wear them into the environment through exhalation, therefore can reduce and/or prevent spreading of respiratory viruses.

Respiratory protective devices can not only enable data communications (for example, via data communication protocols such as Bluetooth®), but also provide functions such as active air supply through the respiratory protective devices. As respiratory protective devices are being used more and more in different situations, many respiratory protective devices do not meet the needs of users as they are plagued by many technical challenges and difficulties. One of the long-felt but unmet needs from the users is sound insulation by the respiratory protective devices.

For example, some respiratory protective devices may provide one or more sound sensor components (such as, but not limited to, microphones) and one or more data communication components (such as, but not limited to, Bluetooth® chips) to enable users to conduct telephone calls while wearing the respiratory protective devices. In such examples, good quality of voice capture by the sound sensor components can be important for users to conduct telephone calls. However, the quality of voice capture can be impacted by the noise from the outside environment outside the respiratory protective devices. For example, when the user is conducting a telephone call in a noisy environment, the noise from the outside environment can negatively impact the quality of voice capture by the sound sensor components. In addition, many users may have privacy concerns when conducting a telephone call in public settings. For example, a user may not want others nearby to eavesdrop on the user's telephone call, and may not want the user's telephone call to disturb others nearby.

As such, a respiratory protective device with good sound insulation not only improves the quality of voice capture, but also can address the privacy concerns from users.

Some respiratory protective devices may provide sound insulation by building a closed space using acoustic insulation materials. However, such respiratory protective devices do not provide ventilation for users, and therefore do not provide a healthy breathing environment for users. As such, it is technically challenging and difficult for respiratory protective devices to provide good sound insulation under the premise of ensuring good ventilation conditions.

Various embodiments of the present disclosure overcome these technical challenges and difficulties.

For example, an example respiratory protective device in accordance with some embodiments of the present disclosure not only meet the need for sound insulation to ensure good quality of voice capture for telephone calls and to protect user privacy, but also provide good ventilation so that users can breathe in a health breathing environment while wearing the example respiratory protective device. In particular, various embodiments of the present disclosure implement various structural features of respiratory protective devices based on principles of sound insulation technology to achieve not only good sound insulation effect, but also active air supply for respiratory protective devices.

In some embodiments, an example respiratory protective device comprises air inlet openings where air is flown into the example respiratory protective device. In such examples, the effective area sizes of the air inlet openings are reduced as much as possible to reduce noise interface from the outer environment while under the condition of ensuring good air supply function.

For example, an example respiratory protective device of the present disclosure may provide a fan mounting component that defines ventilation inlet openings smaller than ventilation outlet openings, effectively reducing the area sizes of the air inlet openings.

In some embodiments, an example fan mounting component comprises acoustic insulation ribs that protrude from the surface of the fan mounting component. In some embodiments, the acoustic insulation ribs comprise sound-absorbing material that can weaken the acoustic interference cancellation associated and improve sound insulation. In some embodiments, the air inlet opening of the mask component and the air outlet opening of the mask component are positioned on different portions of the mask component, resulting in more contact between the sound wave and the sound-absorbing material of the acoustic insulation ribs and improving the sound insulation effects of the mask component.

In some embodiments, the fan mounting component provides one or more curved ventilation channels that each connects a ventilation inlet opening to a ventilation outlet opening. In some embodiments, the curvature of the curved ventilation channels provide technical benefits and advantages such as, but not limited to, enabling acoustic interference to offset energy and improving sound insulation.

In some embodiments, an example respiratory protective device comprises a central acoustic insulation insert that is secured to an inner surface of the example respiratory protective device and comprises one or more insulation ribs. In some embodiments, the insulation ribs protrude from the central acoustic insulation insert and comprise acoustic insulation materials. As such, the central acoustic insulation insert can further improve the sound insulation of the example respiratory protective device. For example, the central acoustic insulation insert can create air layers surrounding both the left side and the right side of the mask component (for example, both the left acoustic insulation portion and the right acoustic insulation portion of the mask component) and between the inside and the outside of the mask component. As such, example fan mounting components in accordance with some embodiments of the present disclosure can cause acoustic energy to oscillate and cancel each other out.

As illustrated in the examples above, example respiratory protective devices in accordance with some embodiments of the present disclosure incorporate one or more of fan mounting component(s) and/or central acoustic insulation insert (in addition to or in alternative of other structure elements and shapes of the respiratory protective device) to achieve sound insulation and ensure continuity of the respiratory protective device. Various embodiments of the present disclosure provide various technical improvements and advantages in addition to providing both good sound insulation and good ventilation.

For example, example embodiments of the present disclosure can enrich the variety of respiratory protective device products and provide differentiated choices for users (for example, with focuses on protecting privacy, ensuring call quality, and/or enhancing user experience), therefore meet the demands from users.

In addition, example respiratory protective devices with sound insulation function can not only meet users' needs for reliable call quality and privacy protection, but also lead to the application of new technologies (such as, but not limited to, speech recognition). For example, the sound insulation solution in example embodiments of the present disclosure can greatly contribute to the environmental noise cancellation (ENC) function thanks to the decreased noise impact from outside the respiratory protective devices. In addition, respiratory protective devices with sound insulations can pave the way for new technological applications such as, but not limited to, speech recognition. As such, the integration of sound insulation in various embodiments of the present disclosure can further enrich the variety of products and provide users with more choices.

As such, various embodiments of the present disclosure provide technical improvements and advantages associated with respiratory protective devices, details of which are described herein.

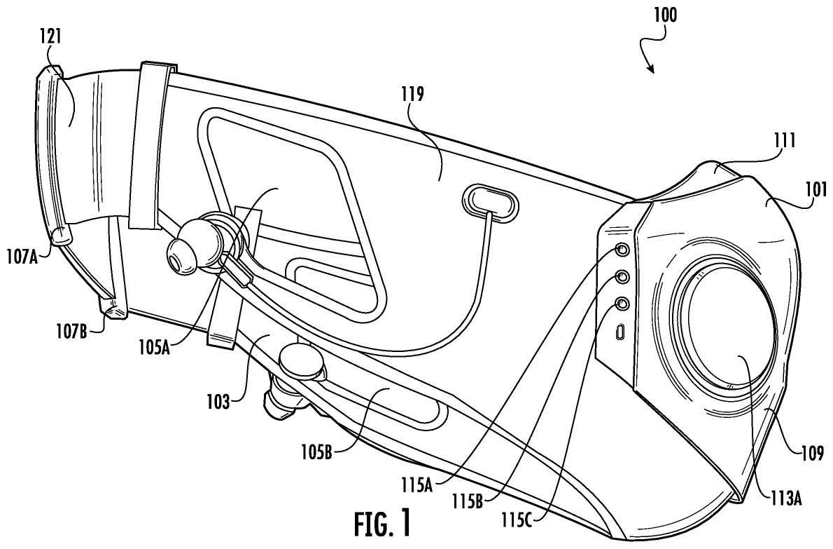

Referring now to FIG. 1, an example perspective view of an example respiratory protective device 100 (also referred to as a respiratory protective equipment) in accordance with some example embodiments described herein is illustrated.

In some embodiments, the example respiratory protective device 100 is in the form of a respirator or a mask. For example, as shown in FIG. 1, the example respiratory protective device 100 comprises a mask component 101 and a strap component 103.

While the description above provides an example of a respiratory protective device in the form of a respirator/mask, it is noted that the scope of the present disclosure is not limited to the description above. In some examples, an example respiratory protective device may be in one or more additional and/or alternative forms.

Referring back to FIG. 1, in some embodiments, the strap component 103 may be in the form of a strap that connects or fastens one end of the mask component 101 to another end of the mask component 101.

In some embodiments, the strap component 103 comprises at least one non-elastic portion 119 and at least one elastic portion 121. In some embodiments, the at least one elastic portion 121 is connected to the at least one non-elastic portion 119.

In some embodiments, the at least one non-elastic portion 119 may comprise nonelastic materials or materials with low elasticity such as, but not limited to, cotton, yarns, fabric (including, but not limited to, woven fabric, non-woven fabric), and/or the like. In some embodiments, the mask component 101 is secured on the at least one non-elastic portion 119.

In some embodiments, at least one elastic portion 121 may comprise elastic material(s) such as, but not limited to, polymers, thermoplastic elastomers (TPE), and/or the like. In some embodiments, the at least one elastic portion 121 allows the strap component 103 to adapt to different head sizes of users.

For example, in the example shown in FIG. 1, the at least one elastic portion 121 of the strap component 103 may be inserted through one or more strap bucket components (such as the strap bucket component 107A and the strap bucket component 107B as shown in FIG. 1). In some embodiments, the one or more strap bucket components (such as the strap bucket component 107A and the strap bucket component 107B as shown in FIG. 1) may be in the form of one or more buckles that include, but not limited to, a tri-glide buckle. In some embodiments, when the one or more strap bucket components (such as the strap bucket component 107A and the strap bucket component 107B as shown in FIG. 1) move along the at least one elastic portion 121 of the strap component 103, the length of the strap component 103 is adjusted. As such, a user can adjust the length of the strap component 103 so that the example respiratory protective device 100 can be secured to a user's face.

In some embodiments, the strap component 103 may comprise an ear opening 105A and an ear opening 105B. When the example respiratory protective device 100 is worn by a user, the ear opening 105A and the ear opening 105B may allow the user's left ear and right ear to pass through.

In some embodiments, the mask component 101 is connected or fastened to the strap component 103. In the example shown in FIG. 1, the mask component 101 is secured to the at least one non-elastic portion 119 of the strap component 103. For example, the mask component 101 may be fastened to the at least one non-elastic portion 119 of the strap component 103 through one or more chemical glues. Additionally, or alternatively, the mask component 101 may be fastened to the at least one non-elastic portion 119 of the strap component 103 through one or more fastener components (such as, but not limited to, one or more snap buttons).

While the description above provides an example fastening mechanism to secure the mask component to the strap component, it is noted that the scope of the present disclosure is not limited to the description above. In some examples, an example mask component may be secured to an example strap component through one or more additional and/or alternative mechanisms. For example, a first end of the strap component can be connected to a first end of the mask component, and a second end of the strap component can be connected to a second of the mask component. In this example, the first end of the mask component is opposite to the second end of the mask component.

As described above, the mask component 101 may be in the form of a mask or a respirator. In the example shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or is attached to and extends from a periphery and/or edge of or an inner shell component of the mask component as described herein).

In some embodiments, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. As described above, the example respiratory protective device 100 includes a strap component 103 that allows the example respiratory protective device 100 to be secured to the user's head. As such, the face seal component 111 can create at least partially enclosed (or entirely enclosed) space between at least a portion of the user's face (e.g., mouth, nostrils, etc.) and the example respiratory protective device 100, details of which are described herein.

In some embodiments, the mask component 101 comprises one or more puck components that cover one or more inhalation filtration components of the example respiratory protective device 100. In some embodiments, each of the puck components is in the form of a circular cover structure. Additionally, or alternatively, each of the puck components can be in other shapes and/or forms.

In the example shown in FIG. 1, the example respiratory protective device 100 comprises a first puck component 113A that is disposed on a left side of the outer shell component 109 and a second puck component that is disposed on a right side of the outer shell component 109. In such an example, the first puck component 113A covers a first inhalation filtration component that is disposed on the left side of the mask component 101, and the second puck component covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C as shown in FIG. 1). In some embodiments, each of the one or more key components is a physical button that may allow a user to manually control operations of various components of the mask component 101 (such as, but not limited to, the fan components as described herein) and/or other devices that are in electronic communication with the example respiratory protective device 100 (such as, but not limited to, earpiece devices).

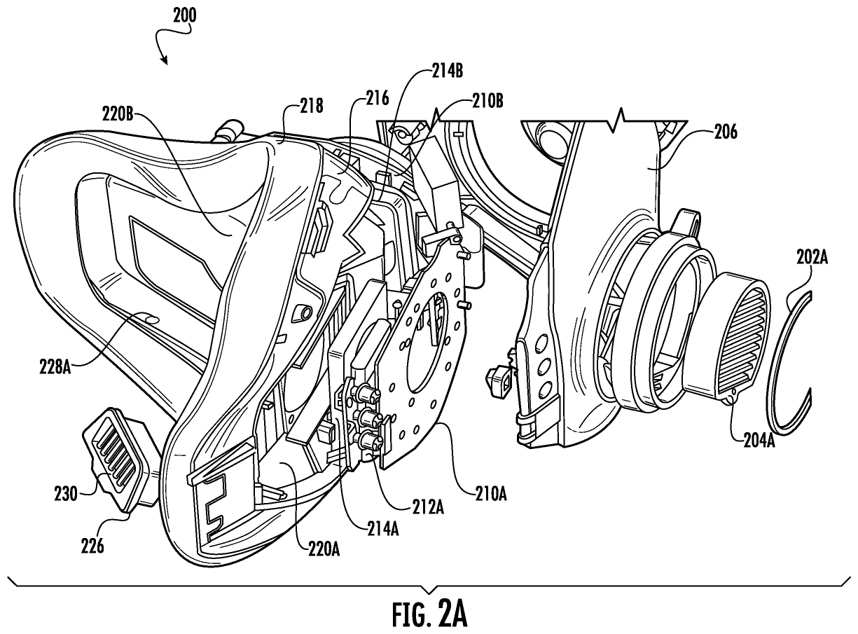

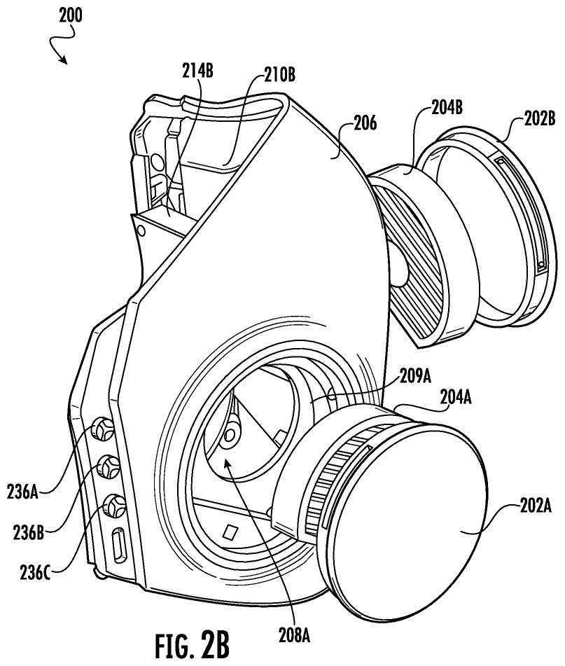

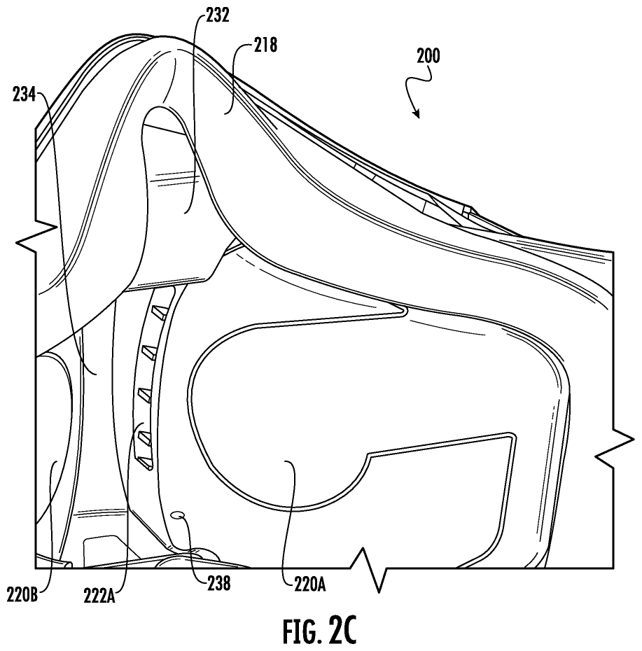

Referring now to FIG. 2A, FIG. 2B, and FIG. 2C, example views of an example mask component 200 in accordance with some example embodiments of the present disclosure are illustrated. In particular, FIG. 2A illustrates an example exploded view of the example mask component 200, FIG. 2B illustrates another example exploded view of example components of the example mask component 200, and FIG. 2C illustrates an example back view of the example mask component 200.

As shown in FIG. 2A, the mask component 200 comprises an outer shell component 206 and an inner shell component 216.

In some embodiments, the inner shell component 216 may be in a shape that is based on the contour of the user's face. In particular, when the mask component 200 is worn by a user, at least a portion of the user's face (such as, but not limited to, mouth, nostrils) are housed within the inner shell component 216.

In some embodiments, the mask component 200 may comprise a face seal component 218. In some embodiments, the face seal component 218 is attached to and extends from a periphery and/or edge of the inner shell component 216. Similar to the face seal component 111 described above in connection with FIG. 1, the face seal component 218 may comprise soft material such as, but not limited to, silica gel. In some embodiments, when the mask component 200 is worn by a user, the face seal component 218 and an inner surface of the inner shell component 216 create an enclosed space between at least a portion of the user's face (e.g., on the mouth, nostrils, etc.) and the mask component 200.

Similar to the shape of the inner shell component 216 described above, the shape of the outer shell component 206 may be based on a contour of the user's face. In some embodiments, when the mask component 200 is assembled, the inner surface of the outer shell component 206 is secured to an outer surface of the inner shell component 216.

In some embodiments, the inner shell component 216 may comprise one or more acoustic insulation portions on the outer surface of the inner shell component 216. In particular, each of the one or more acoustic insulation portions may be sunken or depressed from the outer surface of the inner shell component 216. In the example shown in FIG. 2A and FIG. 2C, the inner shell component 216 may comprise acoustic insulation portions such as, but not limited to, an right acoustic insulation portion 220A that is on a right side of the inner shell component 216 and an left acoustic insulation portion 220B that is on a left side of the inner shell component 216. In such examples, the right side and the left side are viewed from the perspective of a user who is wearing the mask component 200.

In some embodiments, when the inner surface of the outer shell component 206 is secured to outer surface of the inner shell component 216, the acoustic insulation portions of the inner shell component 216 (e.g., the right acoustic insulation portion 220A and left acoustic insulation portion 220B) may create space between the inner shell component 216 and the outer shell component 206.

In some embodiments, one or more components of the mask component 200 are housed, disposed, or positioned within the space formed by the acoustic insulation portions of the inner shell component 216 (e.g., the right acoustic insulation portion 220A and the left acoustic insulation portion 220B) and the outer shell component 206. For example, one or more circuit board components, one or more power charging components, and one or more fan components may be disposed in the space that is defined by the acoustic insulation portions of the inner shell component 216 and the outer shell component 206.

In the examples shown in FIG. 2A, FIG. 2B, and FIG. 2C, a circuit board component 210A, a power charging component 212A, and a fan component 214A are disposed in the space that is defined by the right acoustic insulation portion 220A of the inner shell component 216 and the outer shell component 206. Additionally, or alternatively, a circuit board component 210B, a power charging component, and a fan component 214B are disposed in the space that is defined by the left acoustic insulation portion 220B and the outer shell component 206.

In some embodiments, an example circuit board component comprises a medium or a substrate where one or more electronic components can be secured to and in electronic communications with one another. In some embodiments, an example circuit board component may be in the form of one or more printed circuit boards (PCBs). For example, the example circuit board component may comprise one or more layers such as, but not limited to, a conductive layer and an insulating layer. In such an example, the conductive layer defines conductive pads and patterns of traces and wires that connect the conductive pads.

In some embodiments, one or more electronic components may be soldered, fixed, or otherwise electronically coupled to one or more conductive pads, such that the one or more electronic components can be in electronic communications with one another. Examples of the electronic components include, but are not limited to, a main controller component, an analog-to-digital converter component, a device data communication component, and/or the like.

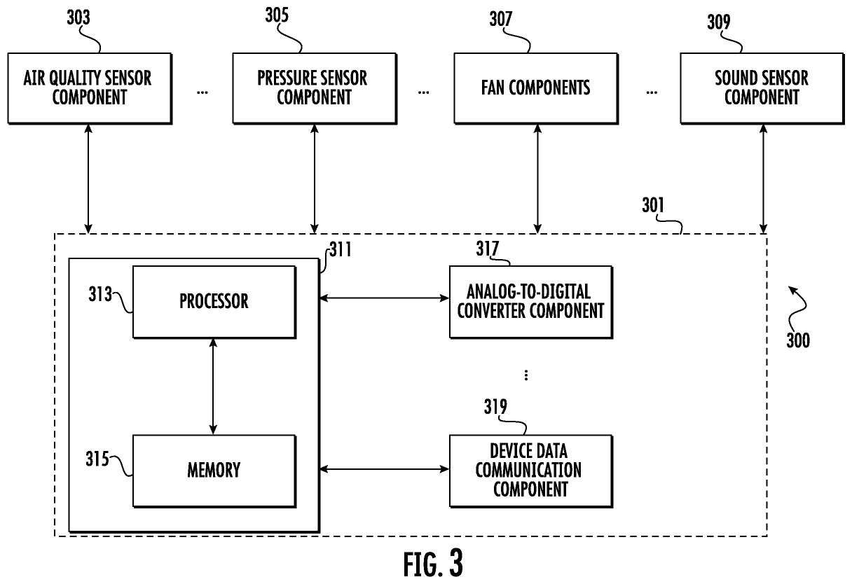

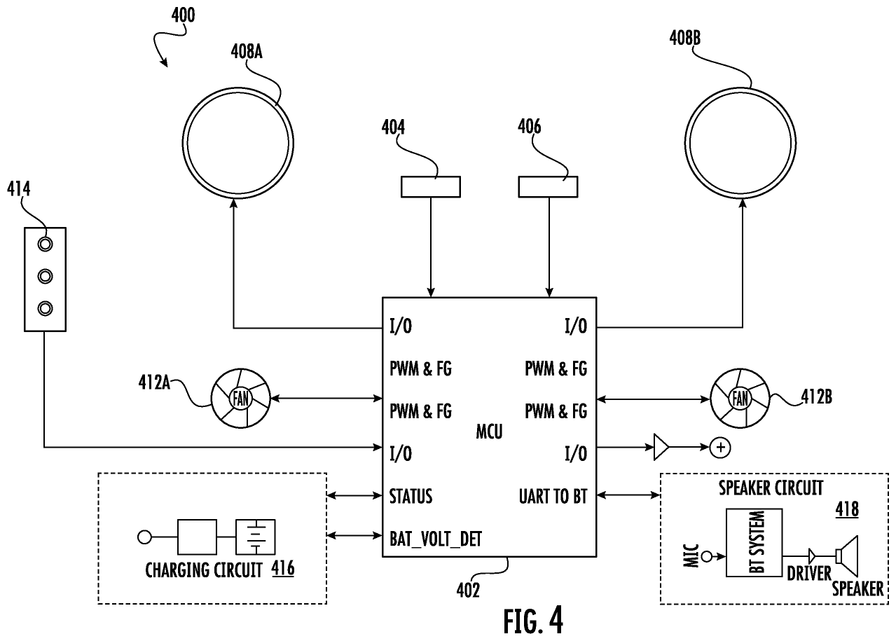

In some embodiments, a main controller component is electronically coupled to the circuit board component. For example, an example main controller component in accordance with some embodiments of the present disclosure may be in the form of a microcontroller or a microcontroller unit. In such an example, the pins of the microcontroller or the microcontroller unit can be securely connected and electronically coupled to the conductive pads of the circuit board component. Additional details associated with the main controller component are described herein, including, but not limited to, those described in connection with at least FIG. 3 and FIG. 4.

Additionally, or alternatively, an analog-to-digital converter component is electronically coupled to the circuit board component. For example, an example analog-to-digital converter component in accordance with some embodiments of the present disclosure may be in the form of an analog-to-digital converter (ADC) that converts an analog signal into a digital signal. Additional details associated with the analog-to-digital converter component are described herein, including, but not limited to, those described in connection with at least FIG. 3.

Additionally, or alternatively, a device data communication component is electronically coupled to the circuit board component. For example, an example device data communication component in accordance with some embodiments of the present disclosure may be in the form of semiconductor integrated circuits (IC) that may comprise one or more transmitters and/or one or more receivers. In some embodiments, an example device data communication component may support one or more data communication protocols, including, but not limited to, those described in connection with at least FIG. 3.

While the description above provides an example of a circuit board component and example components that are securely connected and/or electronically coupled to an example circuit board component, it is noted that the scope of the present disclosure is not limited to the description above. For example, an example mask component may comprise only one circuit board component. Additionally, or alternatively, an example circuit board component may comprise more than one PCB. Additionally, or alternatively, an example circuit board component may connect one or more other electronic components.

In some embodiments, an example fan component may comprise an electric fan. In some embodiments, the mask component comprises one or more fan components that are disposed in the space defined by an acoustic insulation portion of the inner shell component and the outer shell component. For example, the example fan component may be disposed on the outer surface of the acoustic insulation portion of the inner shell component.

In the example shown in FIG. 2A, the mask component 200 comprises a fan component 214A and a fan component 214B. In some embodiments, the fan component 214A may be disposed on the right side of the mask component 200 and in the space that is defined by the right acoustic insulation portion 220A of the inner shell component 216 and the outer shell component 206. In some embodiments, the fan component 214B may be disposed on the left side of the mask component 200 and in the space that is defined by the left acoustic insulation portion 220B of the inner shell component 216 and the outer shell component 206.

While the description above provides an example mask component comprising two fan components, it is noted that the scope of the present disclosure is not limited to the description above. In some examples, an example mask component may comprise less than two or more than two fan components.

In some embodiments, an example fan component may operate at different rotation speeds. For example, the example fan component may be in the form of a stepped fan that provides different, predetermined settings for rotation speeds. Additionally, or alternatively, the example fan component may be in the form of a stepless fan that enables continuous adjustment of the rotation speed.

In some embodiments, an example fan component may operate at different rotational directions. For example, the example fan component may operate in a forward direction or a reverse direction. As an example, when the example fan component operates in the forward rotational direction, the electric fan of the example fan component may rotate counter-clockwise (when viewing from a user wearing the mask component 200) and/or may operate as a blower that draws air from outside the mask component 200 to inside the mask component 200. As another example, when the example fan component operates in the reverse rotational direction, the example fan component may rotate clockwise (when viewing from a user wearing the mask component 200) and/or may operate as an exhaust/ventilation fan that draws air from inside the mask component 200 to outside the mask component 200.

In some embodiments, the one or more fan components are electronically coupled to the main controller component on the example circuit board component, such that the one or more fan components and the main controller component are in data communications with one another.

In some embodiments, various operation parameters of the fan components (such as, but not limited to, the start time, the stop time, the rotational directions (e.g., forward direction or reverse direction) and/or the rotation speed) may be controlled and/or adjusted by the main controller component.

For example, the main controller component may transmit a fan component activation signal to the fan component that causes the fan component to start operating (e.g., causes the electric fan to start rotating). In some embodiments, the fan component activation signal comprises a rotation speed value that indicates the speed for the fan component.

Additionally, or alternatively, the main controller component may transmit a fan component deactivation signal to the fan component that causes the fan component to stop operating (e.g., causes the electric fan to stop rotating).

Additionally, or alternatively, the main controller component may transmit a forward rotation start signal to a fan component that causes the fan component to start forward rotation (e.g., start operating as a blower that draws air from outside the mask component 200 towards inside the mask component 200). In some embodiments, the forward rotation start signal may include a forward rotation speed value that indicates the speed for the fan component. Additionally, or alternatively, the main controller component may transmit a forward rotation stop signal to the fan component that causes the fan component to stop forward rotation.

Additionally, or alternatively, the main controller component may transmit a reverse rotation start signal to a fan component that causes the fan component to start reverse rotation (e.g., start operating as an exhaust fan that draws air from inside the mask component 200 towards outside the mask component 200). In some embodiments, the reverse rotation start signal may include a reverse rotation speed value that indicates the speed for the fan component. Additionally, or alternatively, the main controller component may transmit a reverse rotation stop signal to the fan component that causes the fan component to stop reverse rotation.

In some embodiments, various operation parameters of the fan components (such as, but not limited to, the start time, the stop time, the rotational directions (e.g., forward direction or reverse direction) and/or the rotation speed) may be read or determined by the main controller component.

For example, the main controller component may receive one or more fan speed signals from the one or more fan components. In such an example, each of the one or more fan speed signals comprises a rotation speed indication associated with the corresponding fan component, and the rotation speed indication indicates a current rotation speed of the electric fan of the fan component.

In some embodiments, the power charging component 212A is electronically coupled to one or more electronic components on the circuit board component 210A (such as, but not limited to, the main controller component) and to one or more fan components (such as, but not limited to, the fan component 214A and the fan component 214B). In some embodiments, the power charging component 212A may provide power to the one or more electronic components on the circuit board component 210A (such as, but not limited to, the main controller component) and to one or more fan components (such as, but not limited to, the fan component 214A and the fan component 214B).

For example, the power charging component 212A may comprise a device power source component.

In some embodiments, the device power source component refers to an electronic component that provides a source of electrical energy. In some embodiments, an example device power source component in accordance with some embodiments of the present disclosure may be in the form of, such as but not limited to, one or more batteries, one or more supercapacitors, one or more ultracapacitors, and/or the like.

In some embodiments, the device power source component is electronically coupled to one or more electronic components associated with the respiratory protective device (such as, but not limited to, the main controller component). In such examples, the device power source component provides electrical energy to these electronic components.

In some embodiments, the example device power source component is rechargeable. For example, an example device power source component in accordance with some embodiments of the present disclosure can be recharged through, for example, a wireless charger circuit, a Universal Serial Bus (USB) charger circuit, an integrated circuit (IC) battery charger circuit, and/or the like.

Additionally, in some embodiments, the power charging component 212A may comprise the device power source component and a power charging circuit component.

In some embodiments, the device power source component can charge other electronic components through the charging circuit component. For example, the power charging circuit component may be electronically coupled to the device power source component and one or more other electronic components that are associated with the respiratory protective device (such as, but not limited to, the main controller component). In such an example, the power charging circuit component transfers electrical energy from the device power source component to the one or more other electronic components. In some embodiments, the power charging circuit component optimizes the electrical energy from the device power source component for consumption by other electronic components. For example, the power charging circuit component may comprise one or more voltage regulators so that a constant voltage can be provided to other electronic components. Additionally, or alternatively, the power charging circuit component may comprise one or more voltage divider circuits so that a suitable voltage can be provided to other electronic components.

While the description above provides example components (such as, but not limited to, circuit board components, fan components, and power charging components) that are housed, disposed, or positioned within the space formed by the acoustic insulation portions of the inner shell component 216 and the outer shell component 206, it is noted that the scope of the present disclosure is not limited to the examples above. In some embodiments, circuit board components, fan components, and/or power charging components may be disposed or positioned outside the space formed by the acoustic insulation portions of the inner shell component 216 and the outer shell component 206. In some embodiments, one or more other components may additionally or alternatively be housed, disposed, or positioned within the space formed by the acoustic insulation portions of the inner shell component 216 and the outer shell component 206.

Referring back to FIG. 2B, the mask component 200 may comprise one or more key components such as, but not limited to, a key component 236A, a key component 236B, and a key component 236C. In some embodiments, the one or more key components may be disposed on an outer surface of the outer shell component 206. In some embodiments, each of the one or more key components may provide a button that allows a user to control and/or adjust the operations of various electronic components described herein (such as, but not limited to, fan components, earpieces, and/or the like).

In some embodiments, when the mask component 200 is worn by a user, the user can inhale through the mask component 200. In some embodiments, the air inhaled by the user is filtered by one or more inhalation filtration components.

For example, the mask component 200 may comprise one or more inhalation filtration components (such as, but not limited to, inhalation filtration component 204A and inhalation filtration component 204B). In some embodiments, each of the one or more inhalation filtration components may comprise a filter media element that comprise filter material for filtering air. Examples of filter material include, but are not limited to, high efficiency particulate air (HEPA) filters.

While the description above provides an example mask component comprising two inhalation filtration components, it is noted that the scope of the present disclosure is not limited to the description above. In some examples, an example mask component may comprise less than two or more than two inhalation filtration components.

In some embodiments, the mask component 200 comprises one or more puck components (such as, but not limited to puck component 202A and puck component 202B). In some embodiments, each of the one or more puck components may be positioned to cover one of the inhalation filtration components so as to prolong the lifespan of the mask component 200. For example, the puck component 202A may cover the inhalation filtration component 204A, and the puck component 202B may cover the inhalation filtration component 204B.

In some embodiments, the one or more inhalation filtration components (such as, but not limited to, inhalation filtration component 204A and inhalation filtration component 204B) are disposed in outer shell indentation portion(s) of the outer shell component 206.

For example, as shown in FIG. 2B, the outer shell component 206 of the example mask component 200 may comprise one or more outer shell indentation portions (such as, but not limited to, the outer shell indentation portion 209A). In some embodiments, each of the outer shell indentation portions (such as the outer shell indentation portion 209A) may be sunken or depressed from the outer surface of the outer shell component 206. In the example shown in FIG. 2B, an inhalation filtration component 204A is disposed in the outer shell indentation portion 209A of the outer shell component 206.

In some embodiments, each of the one or more outer shell indentation portions may comprise an air inlet opening. In the example shown in FIG. 2B, the outer shell indentation portion 209A of the outer shell component 206 comprises the air inlet opening 208A.

In some embodiments, each of the one or more inhalation filtration components (that are disposed in an outer shell indentation portion of an outer shell component) is positioned to at least partially or fully cover an air inlet opening of the outer shell indentation portion. In the example shown in FIG. 2B, the inhalation filtration component 204A is positioned on the outer shell indentation portion 209A of the outer shell component 206 and at least partially covers the air inlet opening 208A of the outer shell indentation portion 209A. As such, air may flow through the inhalation filtration component 204A and be released through the air inlet opening 208A of the outer shell indentation portion 209A.

As described above, an example mask component may comprise one or more fan components that are each disposed on an acoustic insulation portion of the inner shell component 216. In some embodiments, when the mask component 200 is assembled, the outer shell component 206 is secured to the inner shell component 216.

In some embodiments, a fan component (such as, but not limited to, the fan component 214A and the fan component 214B) may comprise a fan inlet and a fan outlet. For example, when the fan component operates, the fan component draws air in from the fan inlet and pushes air out through the fan outlet.

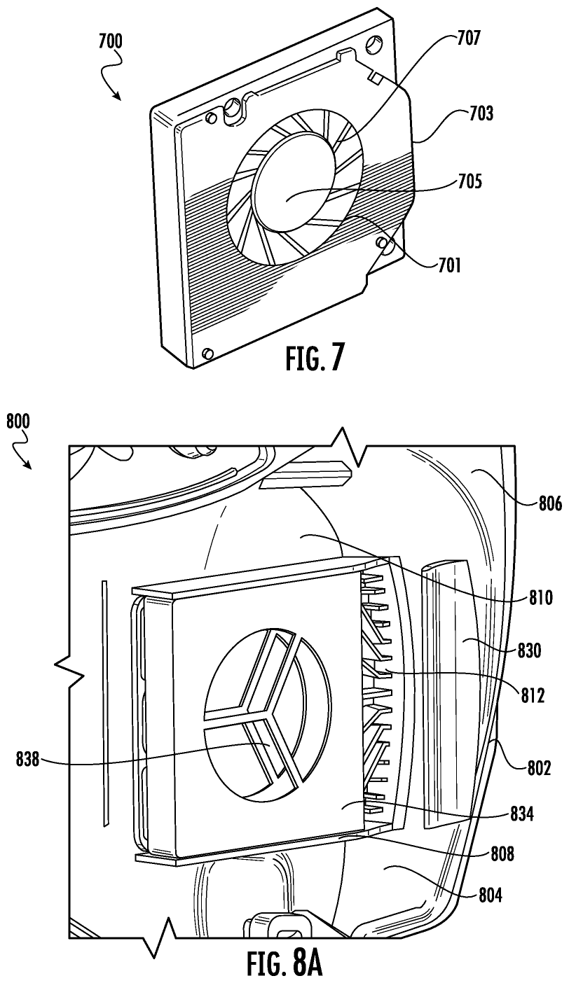

For example, an example fan component in accordance with some embodiments of the present disclosure may be in the form of a centrifugal fan. In such an example, the example fan component comprises impellers in the form of a rotating wheel of blades. When the impellers rotate, the impellers drag air in through the fan inlet and cause the air to enter into circular motions. The circular motions in turn create centrifugal forces, which pushes air out from the fan component through the fan outlet. An example fan component in the form of a centrifugal fan is described and illustrated in connection with at least FIG. 7.

While the description above provides an example centrifugal fan as an example fan component, it is noted that the scope of the present disclosure is not limited to the description above. In some examples, an example fan component may be in one or more additional and/or alternative forms.

In some embodiments, the fan inlet of each fan component is aligned with an air inlet opening on the outer shell indentation portion of the outer shell component. For example, the fan inlet of the fan component 214A is aligned with the air inlet opening 208A on the outer shell indentation portion 209A of the outer shell component 206 shown in FIG. 2B. As such, air may flow from the air inlet opening 208A of the outer shell indentation portion 209A to the fan inlet of the fan component 214A.

As described above, one or more fan components of the example mask component 200 are each disposed on an acoustic insulation portion of the inner shell component 216. In some embodiments, each of the one or more acoustic insulation portions of the inner shell component 216 may comprise one or more air outlet openings. In some embodiments, the one or more fan outlet(s) of the one or more fan components are each aligned with one of the one or more air outlet openings on the inner shell component 216.

In the example shown in FIG. 2C, the right acoustic insulation portion 220A defines a right air outlet opening 222A on the side surface of the right acoustic insulation portion 220A. In some embodiments, the fan outlet of a fan component (for example, the fan component 214A) is aligned with the right air outlet opening 222A. As such, the fan component 214A pushes air out from the fan outlet and through the right air outlet opening 222A of the right acoustic insulation portion 220A.

While the description above describes example air outlet openings that are disposed on the side surface of the acoustic insulation portion of the inner shell component, it is noted that the scope of the present disclosure is not limited to the description above. In some examples, one or more air outlet openings may be additionally or alternatively disposed on the bottom surfaces of the acoustic insulation portion of the inner shell component.

In accordance with some embodiments of the present disclosure, example fan components in the mask component can facilitate the user's breathing.

For example, when the user inhales, the fan component 214A may operate in a forward direction that draws air from outside the mask component 200 towards inside the mask component 200. In this example, the fan component 214A drags air from the outside environment through the inhalation filtration component 204A, then through the air inlet opening 208A on the outer shell indentation portion 209A of the outer shell component 206, and then into the fan inlet of the fan component 214A. Continuing this example, the fan component 214A pushes air out from the fan outlet of the fan component 214A, then through the right air outlet opening 222A of the right acoustic insulation portion 220A, and then into the space between the user's face and the mask component 200. In some embodiments, the fan component 214A can increase the volume and/or the flow rate of air entering the space between the user's face and the mask component 200, thereby facilitating the inhalation of the user.

In some embodiments, when the mask component 200 is worn by a user, the user can exhale through the mask component 200. In some embodiments, the air exhaled by the user is filtered by one or more exhalation filtration components.

For example, referring now to FIG. 2C, an example back view of the example mask component 200 is illustrated. In particular, FIG. 2C illustrates the inner surface of the inner shell component 216 when the example mask component 200 is worn by a user.

In some embodiments, the inner surface 232 of the inner shell component 216 may comprise a nose portion 234, which is located close to a user's nose when the user wears the mask component 200.

In the example shown in FIG. 2C, the example mask component 200 may comprise left air outlet opening that are located on the side surface of the left acoustic insulation portion 220B and/or right air outlet opening (for example, the right air outlet opening 222A) that are located on the side surface of the right acoustic insulation portion 220A. As shown in FIG. 2C, the nose portion 234 is located between the left acoustic insulation portion 220B and the right acoustic insulation portion 220A (e.g., between the left air outlet opening and the right air outlet opening). In particular, the right air outlet opening 222A may be located to the right of the nose portion 234, and the left air outlet opening may be located to the left of the nose portion 234.

In some embodiments, the example mask component 200 may comprise an exhalation opening that is on a middle bottom portion of the inner shell component 216. In some embodiments, the exhalation opening may be located corresponding to the position of the user's mouth. For example, when a user exhales, the breath may be released through the outlet opening.

As shown in FIG. 2A, an exhalation filtration component 226 may be connected to the inner shell component 216 at the outlet opening. For example, the exhalation filtration component 226 may cover the outlet opening. In some embodiments, the exhalation filtration component 226 may comprise a filter media element that comprises filter material for filtering air. Examples of filter material include, but are not limited to, HEPA filters. As such, the breath that is exhaled by the user may be filtered before it is released from inside the mask component 200 to the outside environment.

In accordance with some embodiments of the present disclosure, various sensor components may be implemented in the example mask component 200 to detect, generate, and determine one or more operational signals associated with the example mask component 200.

For example, an example mask component in accordance with some embodiments of the present disclosure may comprise one or more pressure sensor components. For example, when the mask component 200 is worn by a user, the face seal component 218 and an inner surface 232 of the inner shell component 216 create an enclosed space on at least a portion of the user's face (e.g., on the mouth, nostrils, etc.). In some embodiments, a pressure sensor component may comprise a pressure sensor that detects the air pressure within this enclosed space. Examples of the pressure sensor components include, but are not limited to, resistive air pressure transducer or strain gauge, capacitive air pressure transducer, inductive air pressure transducer, and/or the like. In the example shown in FIG. 2A, a pressure sensor component 228A may be disposed on an inner surface of the inner shell component 216. In some embodiments, the pressure sensor component 228A may detect the air pressure within the enclosed space defined by the face seal component 218 and the inner shell component 216 on at least a portion of the user's face.

Additionally, or alternatively, an example mask component in accordance with some embodiments of the present disclosure may comprise one or more humidity components and/or one or more air quality sensor components.

In some embodiments, the mask component 200 comprises a humidity sensor component 230 that is disposed in the exhalation filtration component 226 and at least partially covers the outlet opening of the inner shell component 216. In some embodiments, the humidity sensor component 230 may comprise a humidity sensor that may, for example but not limited to, detect humidity levels within the enclosed space and/or in the breath exhaled by the user. Examples of the humidity sensor component 230 include, but are not limited to, capacitive humidity sensors, resistive humidity sensors, thermal humidity sensors, and/or the like.

In some embodiments, the mask component 200 comprises an air quality sensor component in addition to or in alternative of the humidity sensor component 230. For example, the air quality sensor component may be disposed in the exhalation filtration component 226 and at least partially covers the outlet opening of the inner shell component 216. In some embodiments, the air quality sensor component may comprise an air quality sensor that may, for example but not limited to, determine the air quality levels within the enclosed space and/or in the breath exhaled by the user. Examples of the air quality sensor component include, but are not limited to, volatile organic compounds (VOC) sensors, oxygen sensors, carbon dioxide sensors, and/or the like.

Additionally, or alternatively, an example mask component in accordance with some embodiments of the present disclosure may comprise one or more device sound sensor components. In some embodiments, an example device sound sensor component comprises a sound sensor that converts sound waves into electrical signals. Examples of device sound sensor components include, but are not limited to, microphones, acoustic sensors, noise sensors, and/or the like.

In some embodiments, the one or more device sound sensor components are disposed on an inner surface of the inner shell component 216. For example, referring now to FIG. 2C, an example device sound sensor component 238 is disposed on the inner surface 232 of the inner shell component 216. Additionally, or alternatively, one or more sound sensor components may be disposed at one or more locations in addition to or in alternative of the example shown in FIG. 2B.

While the description above provides example sensor components in an example mask component, it is noted that the scope of the present disclosure is not limited to the description above. For example, an example mask component may comprise one or more additional and/or alternative sensor components.

The example mask component 200 shown in FIG. 2A to FIG. 2C provides various technical benefits and advantages. For example, as shown in FIG. 2C, the air outlet openings (such as, the right air outlet opening 222A) are disposed on the side surface of the right acoustic insulation portion. As such, the air outlet openings are “hidden” from the user when the user wears the example mask component 200, enabling natural breathing from the user wearing the example mask component 200 with reduced or no interference from the air that is pushed out through the air outlet openings. As described above, a fan component is disposed on the outer surface of the acoustic insulation portion. By positioning air outlet openings on the side surfaces of acoustic insulation portions, various embodiments of the present disclosure prevent direct exposure of fan components to users wearing the example mask component while enabling the fan components to push air into the example mask component, thereby improving user safety.

Referring now to FIG. 3, an example circuit diagram of an example respiratory protective device 300 in accordance with some example embodiments described herein is illustrated. In particular, FIG. 3 illustrates example electronic components of an example respiratory protective device in accordance with various example embodiments of the present disclosure.

As shown in FIG. 3, the example respiratory protective device 300 may comprise a circuit board component 301 that is electronically coupled to one or more sensor components (such as, but not limited to, the air quality sensor component 303, the pressure sensor component 305), one or more fan components (such as the fan component 307), the device sound sensor component 309, and/or the like.

As described above, the one or more electronic components are electronically coupled to the circuit board component 301. In the example shown in FIG. 3, the one or more electronic components comprises a main controller component 311, an analog-to-digital converter component 317, a device data communication component 319, and/or the like.

In the example shown in FIG. 3, the main controller component 311 comprises a processor 313 and a memory 315.

In some embodiments, the processor 313 (and/or co-processor or any other processing circuitry assisting or otherwise associated with the processor) may be in communication with the memory 315 via a bus for passing information among components of the apparatus. The memory 315 may be non-transitory and may include, for example, one or more volatile and/or non-volatile memories. In other words, for example, the memory 315 may be an electronic storage device (e.g., a computer readable storage medium). The memory 315 may be configured to store information, data, content, applications, instructions, and/or the like, for enabling the main controller component 311 to carry out various functions in accordance with example embodiments of the present disclosure.

In some embodiments, the processor 313 may be embodied in a number of different ways and may, for example, include one or more processing devices configured to perform independently. Additionally, or alternatively, the processor 313 may include one or more processors configured in tandem via a bus to enable independent execution of instructions, pipelining, and/or multithreading.

For example, the processor 313 may be embodied as one or more complex programmable logic devices (CPLDs), microprocessors, multi-core processors, co-processing entities, application-specific instruction-set processors (ASIPs), and/or controllers. Further, the processor 313 may be embodied as one or more other processing devices or circuitry. The term circuitry may refer to an entirely hardware embodiment or a combination of hardware and computer program products. Thus, the processor 313 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 313 may be configured for a particular use or configured to execute instructions stored in volatile or non-volatile media or otherwise accessible to the processor 313. As such, whether configured by hardware or computer program products, or by a combination thereof, the processor 313 may be capable of performing steps or operations according to embodiments of the present invention when configured accordingly.

The use of the terms “processing circuitry” or “processor” may be understood to include a single core processor, a multi-core processor, multiple processors internal to the apparatus, and/or remote or “cloud” processors.

In some embodiments, the memory 315 stores non-transitory program codes or non-transitory program instructions. In some embodiments, the memory 315 may comprise volatile storage or memory such as, but not limited to, random-access memory (RAM), dynamic random access memory (DRAM), static random access memory (SRAM), fast page mode dynamic random access memory (FPM DRAM), extended data out DRAM (EDO DRAM), synchronous DRAM (SDRAM), double data rate SDRAM (DDR SDRAM), double data rate 2 SDRAM (DDR2 SDRAM), double data rate 3 SDRAM (DDR3 SDRAM), Rambus DRAM (RDRAM), Rambus inline memory module (RIMM), dual in-line memory module (DIMM), single in-line memory module (SIMM), video random access memory (VRAM), cache memory, register memory, and/or the like. Additionally, or alternatively, the memory 315 may comprise non-volatile storage or memory such as, but not limited to, hard disks, read-only memory (ROM), programmable ROM (PROM), erasable programmable ROM (EPROM), electrically erasable programmable ROM (EEPROM), flash memory, SD memory cards, Memory Sticks, conductive-bridging RAM (CBRAM), parameter RAM (PRAM), ferroelectric RAM (FeRAM), resistive RAM (RRAM), SONOS, racetrack memory, and/or the like. Additionally, or alternatively, the memory 315 may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In some embodiments, the processor 313 may be configured to execute instructions stored in the memory 315 or otherwise accessible to the processor. Alternatively, or additionally, the processor 313 may be configured to execute hard-coded functionality. As such, whether configured by hardware or software methods, or by a combination thereof, the processor 313 may represent an entity (e.g., physically embodied in circuitry) capable of performing operations according to an embodiment of the present disclosure while configured accordingly. Additionally, or alternatively, when the processor 313 is embodied as an executor of software instructions, the instructions may specifically configure the processor to perform the algorithms and/or operations described herein when the instructions are executed.

In some embodiments, the memory 315 and the non-transitory program code are configured to, with the processor 313, cause the main controller component 311 to execute one or more methods and/or operations of method(s) described herein. Although the components are described with respect to functional limitations, it should be understood that the particular implementations necessarily include the use of particular hardware. It should also be understood that certain of the components described herein may include similar or common hardware. For example, two sets of circuitries may both leverage use of the same processor, network interface, storage medium, or the like to perform their associated functions, such that duplicate hardware is not required for each set of circuitries. The use of the term “circuitry” as used herein with respect to components of the apparatus should therefore be understood to include particular hardware configured to perform the functions associated with the particular circuitry as described herein.

In some embodiments, the main controller component 311 is electronically coupled to one or more other electronic components on the circuit board component 301. In the example shown in FIG. 3, the main controller component 311 is electronically coupled to, such as but not limited to, the analog-to-digital converter component 317 and the device data communication component 319.

In some embodiments, the analog-to-digital converter component 317 translates/converts analog signals from other components into digital signals for the main controller component 311. For example, the analog-to-digital converter component 317 converts, such as but not limited to, signals from the air quality sensor component 303, signals from the pressure sensor component 305, signals from the one or more fan components (such as the fan component 307), signals from device sound sensor component 309, and/or the like. Examples of the analog-to-digital converter component 317 include, but not limited to, successive approximation (SAR) analog-to-digital converters, delta-sigma analog-to-digital converters, dual slope analog-to-digital converters, pipelined analog-to-digital converters, and/or the like.

In some embodiments, the device data communication component 319 may be any means such as a device or circuitry embodied in either hardware or a combination of hardware and software that is configured to receive and/or transmit data from/to a network and/or any other device, circuitry, or module in communication with the main controller component 311. In this regard, the device data communication component 319 may include, for example, a network interface for enabling communications with a wired or wireless communication network. For example, the device data communication component 319 may include one or more network interface cards, antennae, buses, switches, routers, modems, and supporting hardware and/or software, or any other device suitable for enabling communications via a network. Additionally, or alternatively, the device data communication component 319 may include the circuitry for interacting with the antenna/antennae to cause transmission of signals via the antenna/antennae or to handle receipt of signals received via the antenna/antennae.

In some embodiments, the device data communication component 319 communicates data, content, information, and/or similar terms used herein interchangeably that can be transmitted, received, operated on, processed, displayed, stored, and/or the like to and/or from the main controller component 311.

In some embodiments, such communications can be executed by using any of a variety of wireless communication protocols such as, but not limited to, Bluetooth protocols, near field communication (NFC) protocols, general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, Wibree, wireless universal serial bus (USB) protocols, and/or any other wireless protocol.

Additionally, or alternatively, such communications can be executed by using any of a variety of wired communication protocols, but not limited to, such as fiber distributed data interface (FDDI), digital subscriber line (DSL), Ethernet, asynchronous transfer mode (ATM), frame relay, data over cable service interface specification (DOCSIS), or any other wired transmission protocol.

In accordance with some embodiments of the present disclosure, one or more electronic components in the example mask component (such as, but not limited to, sensor components, fan components, and/or the like) are electronically coupled to one or more electronic components on the circuit board component 301 (such as, but not limited to, the main controller component 311, the analog-to-digital converter component 317, the device data communication component 319, and/or the like).

In some embodiments, the one or more electronic components in the example mask component are electronically coupled to the one or more electronic components on the circuit board component 301 through wired means, and can transmit data to and receive data from electronic components on the circuit board component 301 (such as, but not limited to, the main controller component 311, the analog-to-digital converter component 317, the device data communication component 319, and/or the like). Additionally, or alternatively, the one or more electronic components in the example mask component are electronically coupled to the one or more electronic components on the circuit board component 301 through wireless means.

In the example shown in FIG. 3, one or more pressure sensor components (such as, but not limited to, the pressure sensor component 305) are in electronic communication with the circuit board component 301 (such as, but not limited to, the main controller component 311, the analog-to-digital converter component 317, the device data communication component 319, and/or the like). For example, the pressure sensor component 305 may transmit air pressure indications indicating the detected air pressure to the main controller component 311 or the analog-to-digital converter component 317. In some embodiments, each of the air pressure indications may comprise an air pressure value that corresponds to the air pressure in the enclosed space as defined by the face seal component 218 and the inner shell component 216.

Additionally, or alternatively, the one or more humidity sensor components and/or one or more air quality sensor components (such as, but not limited to, the air quality sensor component 303) are in electronic communication with the circuit board component 301 (such as, but not limited to, the main controller component 311, the analog-to-digital converter component 317, the device data communication component 319, and/or the like). For example, each of the one or more humidity sensor components can transmit humidity indications indicating the detected humidity levels (for example, relative humidity levels) to the main controller component 311 or the analog-to-digital converter component 317. Additionally, or alternatively, each of the one or more air quality sensor components can transmit air quality indications (such as, but not limited to, VOC concentration indications, oxygen concentration indications, carbon dioxide concentration indications, and/or the like) to the main controller component 311 or the analog-to-digital converter component 317.

Additionally, or alternatively, the one or more device sound sensor components (such as, but not limited to, the device sound sensor component 309) are in electronic communication with the circuit board component 301 (such as, but not limited to, the main controller component 311, the analog-to-digital converter component 317, the device data communication component 319, and/or the like). For example, each of the one or more device sound sensor components can generate and transmit sound signals to the main controller component 311, the analog-to-digital converter component 317, and/or the device data communication component 319).

Additionally, or alternatively, the one or more fan components (such as, but not limited to, the fan component 307) are in electronic communication with the circuit board component 301 (such as, but not limited to, the main controller component 311, the analog-to-digital converter component 317, the device data communication component 319, and/or the like). For example, each of the one or more fan components can generate and transmit fan speed signals (e.g., comprising a rotation speed indication associated with the corresponding fan component) to the main controller component 311, the analog-to-digital converter component 317, and/or the device data communication component 319.

While the description above provides example sensor components that are in data communications with the main controller component, it is noted that the scope of the present disclosure is not limited to the description above. In some examples, one or more other sensor components may additionally or alternatively be in electronic communications with the main controller component.

Referring now to FIG. 4, an example circuit diagram of an example respiratory protective device 400 in accordance with some example embodiments described herein is illustrated. In particular, FIG. 4 illustrates example electronic components of an example respiratory protective device in accordance with various example embodiments of the present disclosure.

In the example shown in FIG. 4, the example respiratory protective device 400 may comprise a main controller component 402, similar to the example main controller components described above.

In some embodiments, the main controller component 402 is in electronic communications with other components such as, but not limited to, the pressure sensor component 404, the humidity sensor component 406, one or more light components (such as, but not limited to, a light component 408A and a light component 408B) that are disposed on one or more puck components, one or more fan components (such as, but not limited to, a fan component 412A and fan component 412B), key components 414, and/or the speaker circuit 418.

In some embodiments, the pressure sensor component 404 may transmit air pressure indications to the main controller component 402. As described above, each of the air pressure indications may comprise an air pressure value that corresponds to the air pressure in the enclosed space as defined by the face seal component 218 and the inner shell component 216.

In some embodiments, the humidity sensor component 406 may transmit humidity indications to the main controller component 402. As described above, the humidity indications may indicate relative humidity levels within the enclosed space defined by the face seal component and the inner shell component of the respiratory protective device on at least a portion of the user's face, similar to those described above

While the description above provides an example of a humidity sensor component, it is noted that the scope of the present disclosure is not limited to the description above. In some examples, one or more air quality sensor components are electronically coupled to the main controller component 402 in addition to or in alternative of the humidity sensor component. For example, each of the one or more air quality sensor components may generate air quality indications may indicate for example, but not limited to, VOC concentration indications, oxygen concentration indications, carbon dioxide concentration indications, and/or the like.

In some embodiments, each of the one or more the light components (such as, but not limited to, the light component 408A and the light component 408B) may be in the form of one or more light-emitting diode (LED) rings that are disposed on one or more puck components (for example, on the left puck component and the right puck component). For example, the light component 408A may be disposed on the left puck component and the light component 408B may be disposed on the right puck component. In some embodiments, the main controller component 402 may transmit control signals to the one or more light components so as to adjust the color and/or intensity of light emitted by the one or more light components.

In some embodiments, each of the one or more fan components (such as, but not limited to, the fan component 412A and/or the fan component 412B) can generate and transmit fan speed signals (e.g., comprising a rotation speed indication associated with the corresponding fan component) to the main controller component 402. In some embodiments, the main controller component may transmit a fan component activation signal to a fan component (e.g., the fan component 412A and/or the fan component 412B) that causes the fan component to start operating In some embodiments, the main controller component may transmit a fan component deactivation signal to the fan component that causes a fan component (e.g., the fan component 412A and/or the fan component 412B) to stop operating. In some embodiments, the main controller component may transmit a forward rotation start signal to a fan component (e.g., the fan component 412A and/or the fan component 412B) that causes the fan component to start forward rotation. In some embodiments, the main controller component may transmit a reverse rotation start signal to a fan component (e.g., the fan component 412A and/or the fan component 412B) that causes the fan component to start reverse rotation.

In some embodiments, the main controller component 402 is in electronic communications with the key components 414. For example, when a user presses a button on the key components 414, the key components 414 may transmit a corresponding signal to the main controller component 402. In such an example, based on which button that the user presses, the main controller component 402 triggers one or more operations associated with other components of the respiratory protective device 400 and/or one or more earpiece devices associated with the respiratory protective device 400 (such as, but not limited to, adjusting the volume, triggering noise canceling mode, and/or the like).

In some embodiments, the main controller component 402 is in electronic communication with the speaker circuit 418. For example, the main controller component 402 may transmit control signals to an earphone in the speaker circuit 418 so as to adjust volume, noise canceling mode, and/or the like of the earphone.

In some embodiments, the charging circuit 416 supplies power to main controller component 402 and one or more other electronic components shown in FIG. 4 (such as, but not limited to, the fan component 412A and the fan component 412B).

As described above, there are many technical challenges and difficulties associated with providing sound insulation in respiratory protective devices. For example, one of the challenges is balancing the need for sound insulation and the need for ventilation in masks.

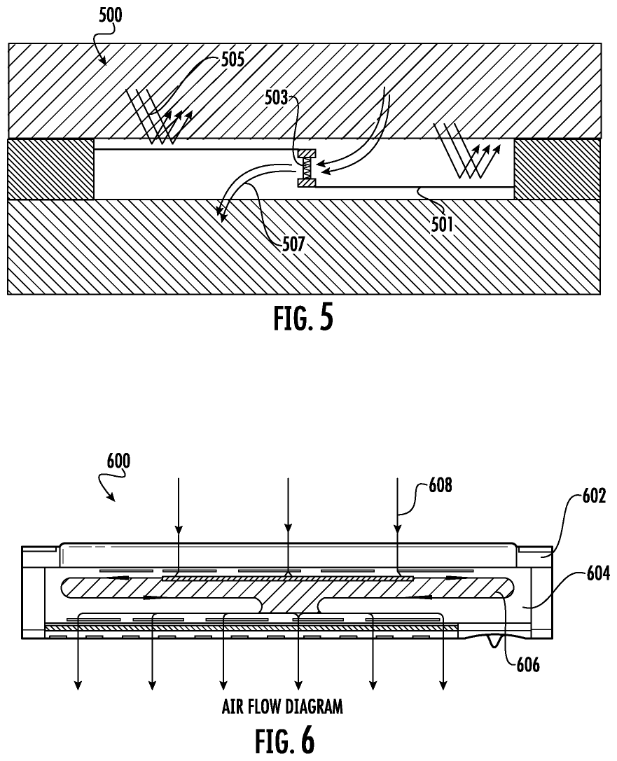

Referring now to FIG. 5, an example diagram 500 is illustrated. In particular, the example diagram 500 illustrates an example portion of an example surface 501 of an example respiratory protective device that comprises an example ventilation opening 503. In some embodiments, the example ventilation opening 503 enables ventilation from inside the example respiratory protective device to outside the example respiratory protective device (as indicated by the arrow 507 showing example air flows).

In the example shown in FIG. 5, a user wearing the example respiratory protective device may produce sound waves 505 from inside the example respiratory protective device. However, the example ventilation opening 503 on the example surface 501 of the example respiratory protective device facilitates the propagations of sound waves 505 to outside the example respiratory protective device, causing significant impacts on the sound insulation effects of the example respiratory protective device. In addition, the rapid circulation of air through the example ventilation opening 503 can further weaken the sound insulation effects of the example respiratory protective device. As such, it is technically challenging to ensure both good active air supply conditions through curved ventilation channels and good sound insulation effect of respiratory protective devices.

In addition, the decibel level of sound insulation of the respiratory protective device depends on not only the attraction coefficient of acoustic insulation materials, but also the incidence angle and frequency of sound waves. As such, the structure of a respiratory protective device should be optimized to increase the decibel level of sound insulation.

Referring now to FIG. 6, an example diagram 600 illustrating example sound wave progressions through an example sound insulation structure 602 in accordance with some embodiments of the present disclosure is provided.

As shown in the example diagram 600, the example sound insulation structure 602 defines an example cavity 604 that stores an acoustic insulation insert 606. The example diagram 600 further illustrates example sound waves 608 progressing through the example sound insulation structure 602.

In some embodiments, the isolation volume of the example sound insulation structure 602 is related to the sound absorption coefficient of acoustic insulation insert 606, the incidence angle of example sound waves 608, and the frequency of example sound waves 608. For example, an example simplified equation of calculating the sound insulation quantity can be calculated as follows:

R=10 lg(1/τ) (dB)

In the above example, R is the sound insulation quantity of the example sound insulation structure 602, and τ is the material transmission coefficient of the acoustic insulation insert 606.

In some embodiments, void areas (such as, but not limited to, opening, apertures, holes and gaps) are the weak links of the example sound insulation structure 602. For example, if the effective area of void in the example sound insulation structure 602 accounts for 1% of the whole area that receives the example sound waves 608, the sound insulation decibel size of the example sound insulation structure 602 cannot exceed 20 dB.

In some embodiments, the acoustic insulation insert 606 comprises acoustic insulation materials that have sound insulation or sound absorption characteristics (for example, but not limited to, materials that are soft, pliable, and/or porous). Examples of acoustic insulation materials in accordance with some embodiments of the present disclosure include, but are not limited to, foam materials (such as, but not limited to, polyurethane foam, melamine foam, and/or the like), fabric materials (such as, but not limited to, porous fabric, acoustical fabric, and/or the like), wool materials (such as, but not limited to, polyester wool, rock wool, and/or the like), and/or the like.

In the example shown in the example diagram 600, the acoustic insulation insert 606 may be in the form of soft and thin plates, which can increase the critical frequency of the example sound waves 608 in order to avoid the coincidence effect in the main frequency range affected by noise.

Referring now to FIG. 7, an example fan component 700 in accordance with some embodiments of the present disclosure is illustrated. In particular, the example fan component 700 may be in the form of a centrifugal air fan.

In some embodiments, the example fan component 700 defines a fan component housing that comprises a fan inlet 701 and a fan outlet 703. In some embodiments, an impeller 705 is positioned within the fan component housing of the example fan component 700.

In some embodiments, the fan inlet 701 is defined on the center of the top surface of the example fan component 700. For example, the fan inlet 701 may be in the form of a central opening. In some embodiments, the fan inlet 701 is positioned on the axis of rotation of the impeller 705.

In some embodiments, the impeller 705 comprises a plurality of blades 707 on a rotating wheel. In some embodiments, when the example fan component 700 is operating, the plurality of blades 707 of the impeller 705 draws/drags air in through the fan inlet 701 and pushes air out through the fan outlet 703.

In some embodiments, the fan outlet 703 is positioned on a side surface of the example fan component 700. In other words, the impeller 705 changes the flow direction of air 90 degrees, as air enters the example fan component 700 through the fan inlet 701 on the center top surface of the example fan component 700 and exits the example fan component 700 through the fan outlet 703 on the side surface of the example fan component 700.

In some embodiments, the example fan component 700 may have a compact size so that it can fit into an example fan mounting component described herein. For example, the example fan component 700 may have a size of 40 millimeters (length) by 40 millimeters (width) by 10 millimeters (height).

While the description above provides an example fan component, it is noted that the scope of the present disclosure is not limited to the description above. In some embodiments, an example fan component may have a different size.

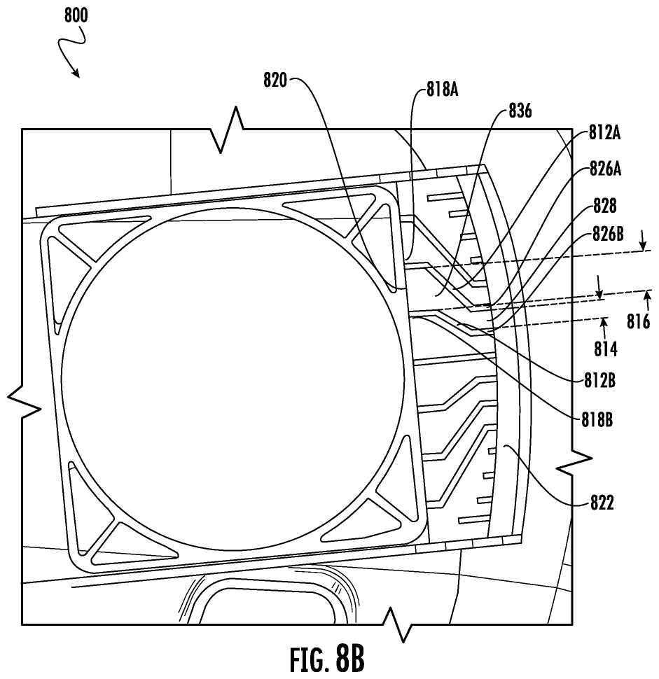

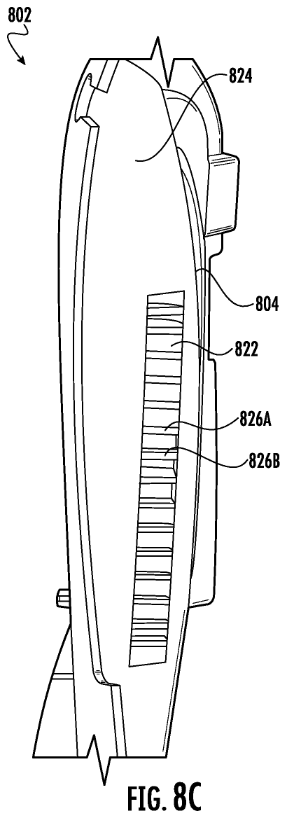

Referring now to FIG. 8A to FIG. 8C, example views associated with an example fan mounting component in accordance with some embodiments of the present disclosure are provided.

In particular, FIG. 8A illustrates an example partially exploded view of an example fan mounting component 808 disposed on an example inner shell component 802. FIG. 8B illustrates an example top view of the example fan mounting component 808 disposed on the example inner shell component 802. FIG. 8C illustrates an example side view of an acoustic insulation portion 804 of the inner shell component 802 in accordance with some embodiments of the present disclosure.

In some embodiments, the respiratory protective device 800 comprises an inner shell component 802. Similar to those described above, the inner shell component 802 defines at least one acoustic insulation portion 804 that is indented on an outer surface 806 of the inner shell component 802.

In some embodiments, the respiratory protective device 800 comprises a fan mounting component 808 that protrudes from an indented surface 810 of the at least one acoustic insulation portion 804.

In some embodiments, the respiratory protective device 800 further comprises at least one fan component in accordance with some embodiments of the present disclosure (such as, but not limited to, the example fan component 700 described above in connection with FIG. 7). In some embodiments, the at least one fan component is secured in the fan mounting component 808. For example, the fan mounting component 808 houses the example fan component.

In the example shown in FIG. 8A, the fan mounting component 808 comprises a fan casing 834 where an example fan component can be secured. For example, the fan casing 834 defines a fan casing inlet opening 838 at the center of the top surface of the fan casing 834, which is aligned with the fan inlet of the fan component when the fan component is stored in the fan casing 834.

In some embodiments, the fan mounting component 808 comprises a plurality of curved ventilation channels that are aligned with the fan outlet of the fan component when the fan component is stored in the fan casing 834. In some embodiments, the plurality of curved ventilation channels are defined by a plurality of acoustic insulation ribs.

For example, as shown in FIG. 8A, the fan mounting component 808 comprises a plurality of acoustic insulation ribs 812 that protrudes from an indented surface 810 of the at least one acoustic insulation portion 804.

In some embodiments, the plurality of acoustic insulation ribs 812 comprises acoustic insulation material that have sound insulation or sound absorption characteristics (for example, but not limited to, materials that are soft, pliable, and/or porous). Examples of acoustic insulation materials for the acoustic insulation ribs 812 include, but are not limited to, foam materials (such as, but not limited to, polyurethane foam, melamine foam, and/or the like), fabric materials (such as, but not limited to, porous fabric, acoustical fabric, and/or the like), wool materials (such as, but not limited to, polyester wool, rock wool, and/or the like), and/or the like

Referring now to FIG. 8B, the plurality of acoustic insulation ribs 812 comprises at least an acoustic insulation rib 812A and an acoustic insulation rib 812B. In some embodiments, the acoustic insulation rib 812A and the acoustic insulation rib 812B define a curved ventilation channel 836.

In the example shown in FIG. 8B, the curved ventilation channel 836 is shaped similar to a letter “S.” In some embodiments, the curvature of the curved ventilation channel 836 provides various technical benefits and advantages.

For example, the curved ventilation channel 836 allows forming inside and outside negative pressure when the fan component is operating, ensuring good ventilation. In some embodiments, at least a portion of the curved ventilation channel 836 can be an acoustic vertical intake channel when sound waves are vertically incident on the acoustic insulation ribs forming the curved ventilation channel 836, providing better sound insulation as compared to that of a straight ventilation channel. In particular, the sound insulation quantity of acoustic insulation materials when the sound waves are vertically incident can be calculated as follows:

R0=10 lg|pi/pt|2=10 lg[1+(ωm/2ρc)2] (dB)

In the equation above, pi is the incident sound pressure, pt is the transmission pressure, m is the surface density, ω is the angular frequency, ρ is the air density, and c is the speed of sound.

As such, the curvature of the curved ventilation channel 836 allows acoustic interference to offset energy and improves sound insulation. With the acoustic insulation material of the acoustic insulation rib 812A and the acoustic insulation rib 812B, the curved ventilation channel 836 can effectively isolate sound, causing attenuation of acoustic energy while maintaining ventilation. In addition, the double layer structure of the curved ventilation channel 836 (formed by the acoustic insulation rib 812A and the acoustic insulation rib 812B) with the “air sandwich” in between the double layer structure can enhance the attenuation of acoustic waves and improve the sound insulation of components. Further, the curvature of the curved ventilation channel 836 can create an uneven surface that causes sound waves to cancel each other out when they are reflected, further weakening the sound waves. As such, the curvature of the curved ventilation channel 836 provides various technical benefits and advantages.

In some embodiments, each of the curved ventilation channels defined by the acoustic insulation ribs 812 comprises a ventilation inlet opening and a ventilation outlet opening. In some embodiments, air pushed out from the fan outlet of the fan component enters the curved ventilation channel through the ventilation inlet opening and exits the curved ventilation channel through the ventilation outlet opening. For example, the curved ventilation channel 836 comprises a ventilation inlet opening 820 and a ventilation outlet opening 828.

In some embodiments, each of the plurality of acoustic insulation ribs 812 comprises a ventilation inlet end. In some embodiments, the ventilation inlet end of two of the plurality of acoustic insulation ribs 812 define a ventilation inlet opening. For example, the acoustic insulation rib 812A comprises a ventilation inlet end 818A, and the acoustic insulation rib 812B comprises a ventilation inlet end 818B. In some embodiments, the ventilation inlet end 818A and the ventilation inlet end 818B defines a ventilation inlet opening 820 of the curved ventilation channel 836.

As described above, at least one fan component is secured in the fan mounting component 808 and defines at least one fan outlet. In some embodiments, the at least one fan outlet is aligned with the ventilation inlet opening 820 of the curved ventilation channel 836. As such, air pushed out from the at least one fan component can enter the curved ventilation channel 836 through the ventilation inlet opening 820.

In some embodiments, each of the plurality of acoustic insulation ribs 812 comprises a ventilation outlet end positioned at the air outlet opening 822. In some embodiments, the ventilation outlet end of two of the plurality of acoustic insulation ribs 812 define a ventilation outlet opening. For example, the acoustic insulation rib 812A comprises a ventilation outlet end 826A, and the acoustic insulation rib 812B comprises a ventilation outlet end 826B. In some embodiments, the ventilation outlet end 826A and the ventilation outlet end 826B define a ventilation outlet opening 828.

Similar to those described above, the at least one acoustic insulation portion 804 defines an air outlet opening 822 on a side surface 824 of the at least one acoustic insulation portion 804 of the inner shell component 802. In some embodiments, the ventilation outlet ends of the plurality of acoustic insulation ribs 812 are positioned at an air outlet opening 822 on the acoustic insulation portion 804 of the inner shell component 802.

Referring now to FIG. 8C, an example side view of the acoustic insulation portion 804 of the inner shell component 802 in accordance with some embodiments of the present disclosure is illustrated. In the example shown in FIG. 8C, the ventilation outlet end 826A and the ventilation outlet end 826B are positioned at the air outlet opening 822 on the acoustic insulation portion 804 of the inner shell component 802. As such, air pushed out through the curved ventilation channel 836 is released through the air outlet opening 822 on the acoustic insulation portion 804 of the inner shell component 802.

Referring back to FIG. 8B, the at least one curved ventilation channel 836 is associated with a ventilation inlet width 816, which refers to a width of the ventilation inlet opening 820 of the curved ventilation channel 836. In some embodiments, the at least one curved ventilation channel 836 is also associated with a ventilation outlet width 814, which refers to a width of the ventilation outlet opening 828 of the curved ventilation channel 836. In some embodiments, the ventilation inlet width 816 is larger than the ventilation outlet width 814.

In some embodiments, the ventilation inlet width 816 being larger than the ventilation outlet width 814 provides various technical benefits and advantages. For example, the smaller ventilation outlet width 814 reduces the effective area size of the air outlet opening 822, which increases the amount of sound insulation. The larger ventilation inlet width 816 increases the air velocity of air pushed from the fan component, which increases ventilation of air. In some embodiments, the further away that the ventilation inlet opening 820 is from the ventilation outlet opening 828, the smaller the effective area of the air outlet opening 822, and the better the sound insulation effect by the fan mounting component 808.

In some embodiments, a ratio between the ventilation inlet width 816 and the ventilation outlet width 814 is in a range between 1:1 and 2:1, which provides various technical benefits and advantages. For example, the range between 1:1 and 2:1 allows the ventilation inlet width 816 to be larger than the ventilation outlet width 814 without restricting the ventilation of air or compromising sound insulation. In other words, the range between 1:1 and 2:1 reduces the effective area size of the air outlet opening 822 without significantly affecting the air flow from the fan component.

In some embodiments, a ratio between the ventilation inlet width 816 and the ventilation outlet width 814 is 2:1, which provides various technical benefits and advantages. For example, the 2:1 ratio can provide an optimal balance between the need for a larger ventilation inlet width 816 and the need for a smaller ventilation outlet width 814. In particular, when the ratio between the ventilation inlet width 816 and the ventilation outlet width 814 is 2:1, the effective area size of the air outlet opening 822 is reduced, the ventilation of air is increased, and the sound insulation effect is improved.

In some embodiments, a ratio between the ventilation inlet width 816 and the ventilation outlet width 814 is more than 2:1, which provides various technical benefits and advantages. For example, when the ratio is more than 2:1, the larger size of the ventilation inlet width 816 can drastically improve the velocity of air from the fan component, while the smaller size of the ventilation outlet width 814 can increase sound insulation by the fan mounting component 808.

While the examples shown in FIG. 8A and FIG. 8B illustrate example fan mounting components, it is noted that the scope of the present disclosure is not limited to these examples. For example, an example fan mounting component in accordance with some embodiments of the present disclosure may comprise more acoustic insulation ribs or less acoustic insulation ribs compared to the examples shown in FIG. 8A and FIG. 8B. Additionally, or alternatively, an example fan mounting component in accordance with some embodiments of the present disclosure may define more curved ventilation channels or less curved ventilation channels compared to the examples shown in FIG. 8A and FIG. 8B.

Referring back to FIG. 8A, the fan mounting component 808 further comprises a fan cover 830 positioned on top of the plurality of acoustic insulation ribs 812. In some embodiments, the fan cover 830 covers the plurality of acoustic insulation ribs 812.

In some embodiments, the fan cover 830 comprises acoustic insulation materials that have sound insulation or sound absorption characteristics (for example, but not limited to, materials that are soft, pliable, and/or porous). Examples of acoustic insulation materials for the fan cover 830 include, but are not limited to, foam materials (such as, but not limited to, polyurethane foam, melamine foam, and/or the like), fabric materials (such as, but not limited to, porous fabric, acoustical fabric, and/or the like), wool materials (such as, but not limited to, polyester wool, rock wool, and/or the like), and/or the like.

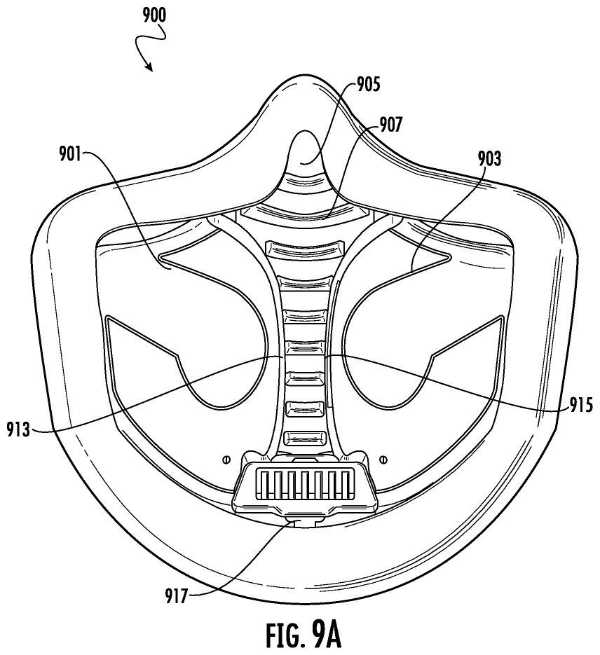

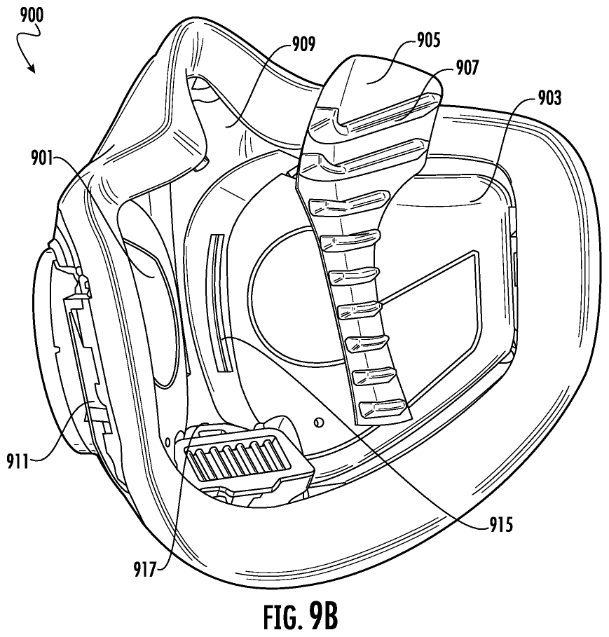

Referring now to FIG. 9A and FIG. 9B, example views associated with an example respiratory protective device 900 in accordance with some embodiments of the present disclosure are illustrated. In particular, FIG. 9A illustrates an example back view of the example respiratory protective device 900, and FIG. 9B illustrates an example exploded view of the example respiratory protective device 900.

In some embodiments, the respiratory protective device 900 comprises a central acoustic insulation insert 905. In some embodiments, the central acoustic insulation insert 905 comprises acoustic insulation materials that have sound insulation or sound absorption characteristics (for example, but not limited to, materials that are soft, pliable, and/or porous). Examples of acoustic insulation materials for the central acoustic insulation insert 905 include, but are not limited to, foam materials (such as, but not limited to, polyurethane foam, melamine foam, and/or the like), fabric materials (such as, but not limited to, porous fabric, acoustical fabric, and/or the like), wool materials (such as, but not limited to, polyester wool, rock wool, and/or the like), and/or the like.

Similar to those described above, the example respiratory protective device 900 comprises at least one acoustic insulation portion. In the example shown in FIG. 9A and FIG. 9B, the example respiratory protective device 900 comprises a left acoustic insulation portion 901 and a right acoustic insulation portion 903. In some embodiments, the central acoustic insulation insert 905 is positioned between the left acoustic insulation portion 901 and the right acoustic insulation portion 903.

Similar to those described above, the inner shell component 911 defines an outlet opening 917. In some embodiments, the central acoustic insulation insert 905 is positioned above the outlet opening 917.

In some embodiments, the central acoustic insulation insert 905 is secured to an inner surface 909 of the inner shell component 911. For example, the central acoustic insulation insert 905 is attached to a central portion of the inner surface 909 of the inner shell component 911 through chemical adhesives (such as, but not limited to, glue).

In some embodiments, the central acoustic insulation insert 905 comprises a plurality of insulation ribs 907. In some embodiments, the plurality of insulation ribs 907 comprises acoustic insulation material that have sound insulation or sound absorption characteristics (for example, but not limited to, materials that are soft, pliable, and/or porous). Examples of acoustic insulation materials for the plurality of insulation ribs 907 include, but are not limited to, foam materials (such as, but not limited to, polyurethane foam, melamine foam, and/or the like), fabric materials (such as, but not limited to, porous fabric, acoustical fabric, and/or the like), wool materials (such as, but not limited to, polyester wool, rock wool, and/or the like), and/or the like.

In some embodiments, the plurality of insulation ribs 907 protrudes from the central acoustic insulation insert 905, which provides various technical benefits and advantages. For example, the protruding structure of the plurality of insulation ribs 907 can weaken the acoustic interference cancellation.

In some embodiments, the plurality of insulation ribs 907 is in parallel arrangement with one another. In some embodiments, each of the plurality of insulation ribs 907 comprises a curved top surface.

In some embodiments, the parallel arrangement and the curved top surface of the plurality of insulation ribs 907 can provide various technical benefits and advantages such as, but not limited to, improved efficiency of air circulation and optimized insulation of sound.

Similar to those described above, the left acoustic insulation portion 901 defines a left air outlet opening 913 on a side surface of the left acoustic insulation portion 901. In some embodiments, the right acoustic insulation portion 903 defines a right air outlet opening 915 on a side surface of the right acoustic insulation portion 903.

In some embodiments, at least one of the plurality of insulation ribs 907 is positioned between the left air outlet opening 913 and the right air outlet opening 915, providing various technical benefits and advantages. For example, positioning the plurality of insulation ribs 907 between the left air outlet opening 913 and the right air outlet opening 915 creates air layers that surround the left acoustic insulation portion 901 and the right acoustic insulation portion 903 and between the inside of the example respiratory protective device 900 and the outside of the example respiratory protective device 900, causing acoustic energy to oscillate and cancel each other out, improving the noise insulation of the example respiratory protective device 900.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A respiratory protective device comprising:
an inner shell component defining at least one acoustic insulation portion that is indented on an outer surface of the inner shell component; and
a fan mounting component protruding from an indented surface of the at least one acoustic insulation portion and comprising a plurality of acoustic insulation ribs, wherein the plurality of acoustic insulation ribs defines at least one curved ventilation channel, wherein a ventilation inlet width associated with the at least one curved ventilation channel is larger than a ventilation outlet width associated with the at least one curved ventilation channel.

2. The respiratory protective device of claim 1, wherein each of the plurality of acoustic insulation ribs comprises a ventilation inlet end, wherein ventilation inlet ends of two of the plurality of acoustic insulation ribs define a ventilation inlet opening.

3. The respiratory protective device of claim 2, further comprising:
at least one fan component secured in the fan mounting component and defining at least one fan outlet, wherein the at least one fan outlet is aligned with the ventilation inlet opening.

4. The respiratory protective device of claim 1, wherein the at least one acoustic insulation portion defines an air outlet opening on a side surface of the at least one acoustic insulation portion of the inner shell component.

5. The respiratory protective device of claim 4, wherein each of the plurality of acoustic insulation ribs comprises a ventilation outlet end positioned at the air outlet opening, wherein ventilation outlet ends of two of the plurality of acoustic insulation ribs define a ventilation outlet opening.

6. The respiratory protective device of claim 1, wherein a ratio between the ventilation inlet width and the ventilation outlet width is in a range between 1:1 and 2:1.

7. The respiratory protective device of claim 1, wherein a ratio between the ventilation inlet width and the ventilation outlet width is 2:1.

8. The respiratory protective device of claim 1, wherein a ratio between the ventilation inlet width and the ventilation outlet width is more than 2:1.

9. The respiratory protective device of claim 1, wherein the plurality of acoustic insulation ribs comprises acoustic insulation material.

10. The respiratory protective device of claim 1, wherein the fan mounting component further comprises a fan cover positioned on top of the plurality of acoustic insulation ribs, wherein the fan cover comprises acoustic insulation material.

11. The respiratory protective device of claim 1, wherein the respiratory protective device further comprises:
a central acoustic insulation insert positioned between a left acoustic insulation portion and a right acoustic insulation portion and comprising a plurality of insulation ribs.

12. The respiratory protective device of claim 11, wherein the central acoustic insulation insert is secured to an inner surface of the inner shell component.

13. The respiratory protective device of claim 11, wherein the plurality of insulation ribs comprises acoustic insulation material.

14. The respiratory protective device of claim 11, wherein the plurality of insulation ribs is in parallel arrangement with one another.

15. The respiratory protective device of claim 11, wherein each of the plurality of insulation ribs comprises a curved top surface.

16. The respiratory protective device of claim 11, wherein the left acoustic insulation portion defines a left air outlet opening.

17. The respiratory protective device of claim 16, wherein the right acoustic insulation portion defines a right air outlet opening.

18. The respiratory protective device of claim 17, wherein at least one of the plurality of insulation ribs is positioned between the left air outlet opening and the right air outlet opening.

19. The respiratory protective device of claim 11, wherein the inner shell component defines an exhalation opening.

20. The respiratory protective device of claim 19, wherein the central acoustic insulation insert is positioned above the exhalation opening.
